(19) United States
(12) Patent Application Publication
(10) Pub. No.: US 2026/0202476 A1
(43) Pub. Date: Jul. 16, 2026

(54) ELECTRONIC MOTOR EMULATOR AND METHOD OF OPERATING THE SAME

(71) Applicant: DELTA ELECTRONICS, INC., Taoyuan City (TW)

(72) Inventors: Ming-Yuan HSIEH, Taoyuan City (TW); Yaow-Ming CHEN, Taoyuan City (TW)

(21) Appl. No.: 19/185,499

(22) Filed: Apr. 22, 2025

(30) Foreign Application Priority Data
Jan. 14, 2025 (CN) 202510058028.9

(51) Int. Cl. G01R 31/34; G06F 30/367; G06F 111/10; G06F 119/06

(52) U.S. Cl. CPC G01R 31/343; G06F 30/367; G06F 2111/10; G06F 2119/06

(57) ABSTRACT

An electronic motor emulator is used to emulate a motor and receive an output signal of a device under test. The electronic motor emulator includes a controller and a power stage circuit. The power stage circuit includes a first three-phase inductor, a back-EMF emulator, and an inductance compensator. The controller correspondingly calculates a three-phase current provided by the device under test according to the output signal, and provides a control signal corresponding to the three-phase current. The EMF emulator emulates a back EMF corresponding to the output signal according to the control signal. The inductance compensator compensates the first three-phase inductor to emulate a magnetizing inductance of the motor so that the power stage circuit extracts the three-phase current according to the back EMF and the magnetizing inductance.

### BACKGROUND

### Technical Field

The present disclosure relates to a motor emulator and a method of operating the same, and more particularly to an electronic motor emulator for testing a motor driver and a method of operating the same.

### Description of Related Art

The statements in this section merely provide background information related to the present disclosure and do not necessarily constitute prior art.

In the field of automotive electronics, motor drivers are undoubtedly an important part. The motor driver should undergo power stage testing before leaving the factory, and at this stage, it is necessary to establish an appropriate test scenario for a device under test (DUT). This means that load conditions need to be created for the device under test. The most direct load condition is to directly connect the device under test to the motor and a dynamometer (equivalent to a controllable torque load). However, this approach has at least the following disadvantages. 1. the size of the power stage testing system is too large due to the configuration of the physical motor. 2. The device under test will generate huge mechanical work during the testing process, which raises safety concerns about the testing execution. 3. The power stage testing system has low efficiency since the energy will go through multiple stages of conversion and loss, and the energy that is ultimately recovered is limited. 4. The power stage testing system needs to be designed according to the specifications of the device under test. Drivers of different specifications can only be applied to specific power stage testing systems. Therefore, the applicability of the power stage testing system is low, and if the motor or the dynamometer needs to be replaced, it will take a lot of time.

In order to solve the above-mentioned problems, the concept of electronic motor emulator (EME) was proposed. The electronic motor emulators are mainly based on power electronics technology, and they use only electronic circuits and current controllers to emulate the current response of any motor. However, since the electronic motor emulator purely uses electronic circuits and current controllers, there is bound to be a significant gap between the test results and those of the physical motor. Especially when the magnetizing inductance inside each motor changes with the rotor, it is difficult for an electronic motor emulator to produce accurate testing results.

Therefore, how to design an electronic motor emulator and a method of operating the same to test the factory-produced motor driver without using a physical motor and accurately emulate the characteristics of the motor to increase the accuracy of the test has become a critical topic in this field.

### SUMMARY

In order to solve the above-mentioned problems, the present disclosure is to provide an electronic motor emulator. The electronic motor emulator emulates a motor, and receives an output signal of a device under test. The electronic motor emulator includes a controller and a power stage circuit. The controller correspondingly calculates a three-phase current provided by the device under test according to the output signal, and provides a control signal corresponding to the three-phase current. The power stage circuit is coupled to the controller and the device under test. The power stage circuit includes a first three-phase inductor, a back-EMF emulator, and an inductance compensator. The first three-phase inductor is coupled to the device under test. The back-EMF emulator is coupled to the first three-phase inductor, and the back-EMF emulator emulates a back EMF corresponding to the output signal according to the control signal. The inductance compensator is coupled to the back-EMF emulator, and the inductance compensator compensates the first three-phase inductor to emulate a magnetizing inductance of the motor. The power stage circuit extracts the three-phase current according to the back EMF and the magnetizing inductance.

In order to solve the above-mentioned problems, the present disclosure is to provide a method of operating an electronic motor emulator. The electronic motor emulator emulates a motor, and the electronic motor emulator includes a first three-phase inductor, a back-EMF emulator, and an inductance compensator. The method comprising steps of: receiving an output signal of a device under test; correspondingly calculating a three-phase current provided by the device under test according to the output signal, and providing a control signal corresponding to the three-phase current; controlling the back-EMF emulator to emulate a back EMF corresponding to the output signal according to the control signal; controlling, by the control signal, the inductance compensator to compensate the first three-phase inductor to emulate a magnetizing inductance of the motor; extracting, by the motor emulator, the three-phase current according to the back EMF and the magnetizing inductance.

The main purpose and effect of the present disclosure is: since the electronic motor emulator can use the inductance compensator to compensate the first three-phase inductor, and use the back-EMF emulator to emulate a back EMF corresponding to the output signal, it is possible to correctly emulate the characteristics of the motor, increase the accuracy of the test to replace the physical motor, and provide an effective test environment for the device under test.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of an electronic motor emulator according to the present disclosure.

FIG. 2A is a schematic model diagram of a motor circuit according to the present disclosure.

FIG. 2B is a schematic model diagram of the motor circuit after Park's transformation according to the present disclosure.

FIG. 3A is a schematic model diagram of a power stage circuit topology according to the present disclosure.

FIG. 3B is a circuit diagram of the power stage circuit topology according to the present disclosure.

FIG. 4A is an equivalent circuit diagram of a variable inductance to emulate a target inductance.

FIG. 4B is an equivalent circuit diagram of a three-phase Y-connected inductance.

FIG. 4C is an equivalent circuit diagram of a three-phase Y-connected emulated inductance.

FIG. 5 is an equivalent circuit diagram of a buck converter that is used to realize the back EMF.

FIG. 6A is a circuit diagram of the power stage circuit topology according to a first embodiment of the present disclosure.

FIG. 6B is a circuit diagram of the power stage circuit topology according to a second embodiment of the present disclosure.

FIG. 7 is a flowchart of a method of operating the motor emulator according to the present disclosure.

FIG. 8 is a circuit block diagram of a motor emulator verification system according to the present disclosure.

FIG. 9A is a comparison diagram of three-phase current waveforms of the verification system according to the present disclosure.

FIG. 9B is a partial enlarged comparison diagram of the three-phase current waveforms at a first time of the verification system according to the present disclosure.

FIG. 9C is a partial enlarged comparison diagram of the three-phase current waveforms at a second time of the verification system according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

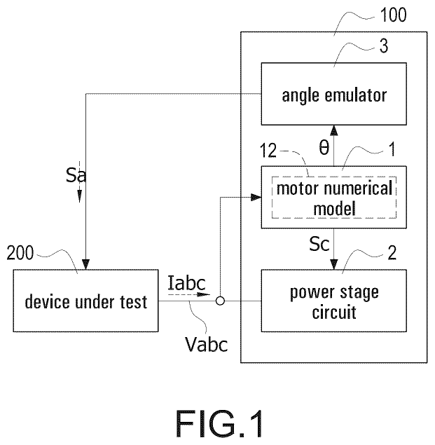

Please refer to FIG. 1, which shows a block circuit diagram of an electronic motor emulator according to the present disclosure. The electronic motor emulator 100 (EME, hereinafter referred to as a motor emulator 100) is used to emulate a real motor, and is coupled to a device under test 200 (DUT, referred to as a motor driver or a driver under test). The motor emulator 100 is mainly composed of circuit components, and mainly provides corresponding feedback according to an output signal Vabc when the device under test 200 provides the output signal Vabc so that the device under test 200 is considered to be connected to a real motor. Therefore, it is not necessary to use a physical motor (i.e., a physical structure including a rotor and a stator) to test the motor driver before it leaves the factory as in the conventional technology. That is, during the test of the device under test 200, the device under test 200 drives the rotor rotating to perform the test. Since the motor emulator 100 in the present disclosure is composed of circuit components, it does not drive the rotor to rotate as a real motor, and therefore does not generate much mechanical power. In addition, the motor emulator 100 can meet the requirements of the device under test 200 by adjusting its internal parameters, and therefore it is not necessary to replace a suitable motor or dynamometer according to the specifications of the device under test 200 in order to test the device under test 200, as that in the conventional technology.

Furthermore, the motor emulator 100 includes a controller 1 and a power stage circuit 2. The controller 1 may include, for example but not limited to, a motor numerical model 12, or a sub-module such as a specific motor program. For example, the motor numerical model 12 may be pre-modeled before physically testing the device under test 200 to acquire the motor numerical model 12, and the motor numerical model 12 may be written into the controller 1, for example but not limited to. Therefore, the motor numerical model 12 can perform numerical calculations by sensing the output signal Vabc of the device under test 200, and predict the dynamic response of the motor to be emulated by numerical calculations. Afterward, the calculated dynamic response of the motor is provided to the controller 1 as a reference, and after appropriate compensation, a control signal Sc is provided accordingly so that the control signal Sc is transmitted to the power stage circuit 2. Therefore, the motor emulator 100 then receives a three-phase current Iabc corresponding to the output signal Vabc and provides feedback corresponding to the motor. Therefore, if the controller 1 is designed properly, the three-phase current Iabc extracted by the motor emulator 100 will be very close to the motor current predicted by the motor numerical model 12. Accordingly, for the device under test 200, it is considered to be connected to a real motor.

In addition, the motor emulator 100 optionally includes an angle emulator 3, and the angle emulator 3 is coupled to the controller 1. Taking the controller 1 including the motor numerical model 12 as an example, the controller 1 provides an emulated angle θ of a rotor corresponding to the motor through the motor numerical model 12, and the angle emulator 3 provides an angle feedback signal Sa to the device under test 200 according to the emulated angle θ. Specifically, in physical operating scenarios using physical motors, rotor angle sensing mechanisms are sometimes used, such as but not limited to encoders, resolvers, and the like. However, for the motor emulator 100, as a virtual motor, there is no physical rotor. On the contrary, the rotor angle exists as a virtual variable in the submodule and is updated iteratively over time. Therefore, if the device under test 200 needs to use rotor angle feedback, the motor emulator 100 in the present disclosure may include an angle emulator 3. The angle emulator 3 is used to convert the virtual angle variable in the submodule into the signal form of the angle sensor in the physical type (i.e., the angle feedback signal Sa, such as but not limited to the signal of the encoder, or the signal of the resolver) so that the device under test 200 can receive the angle feedback signal Sa and realize the original motor control function of the device under test 200. In one embodiment, the circuit block diagram of the motor emulator 100 shown in FIG. 1 is only a schematic example. In practical applications, other sub-blocks may be selectively added according to the requirements of the device under test 200, and are not limited here.

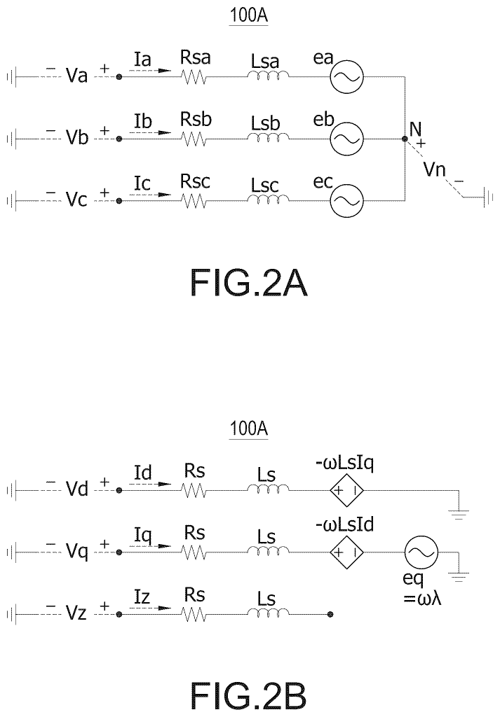

Please refer to FIG. 2A, which shows a schematic model diagram of a motor circuit according to the present disclosure, please refer to FIG. 2B, which shows a schematic model diagram of the motor circuit after Park's transformation according to the present disclosure, and also refer to FIG. 1. In FIG. 2A and FIG. 2B, the motor 100A emulated by the motor emulator 100 of FIG. 1 is a three-phase permanent magnet synchronous motor (PMSM) as an illustrative example (the reason will be further explained later), but is not limited to this, which can be applied to known types, and the modeling model is similar to the motor 100A of FIG. 2A. In FIG. 2A, the output signal Vabc provided by the device under test 200 includes output voltages (Va, Vb, Vc) of the three-phase abc axis, and the three-phase current Iabc extracted by the physical motor 100A includes currents (Ia, Ib, Ic) of the three-phase abc axis. Furthermore, a physical motor generally includes coil resistance (Rsa, Rsb, Rsc), magnetizing inductance (Lsa, Lsb, Lsc) and back EMF (ea, eb, ec). In particular, the three-phase coil resistance (Rsa, Rsb, Rsc) and the magnetizing inductance (Lsa, Lsb, Lsc) may be acquired as follows since the motor 100A has a symmetrical structure: Rsa=Rsb=Rs=Rs and Lsa=Lsb=Lsc=Ls. Since the three-phase back EMF is a sine wave voltage with a 120° phase difference, it may be expressed as:

$$[ \text{} \begin{matrix}ea \\ eb \\ ec\end{matrix} \text{} ] = ω λ [ \text{} \begin{matrix}sin θ \\ sin ( θ - \frac{2 π}{3} ) \\ sin ( θ + \frac{2 π}{3} )\end{matrix} \text{} ] \qquad equation ( 1 )$$

After the Park's transformation of the three-phase abc-axis circuit model of FIG. 2A, a dqz-axis circuit model as shown in FIG. 2B can be acquired. Its characteristics are that the inductance has coupling terms, and the back EMF only appears on the q axis, and the z axis is an open-circuit state, and therefore it can be expressed as:

$$[ \text{} \begin{matrix}Vd \\ Vq\end{matrix} \text{} ] = Rs [ \text{} \begin{matrix}Id \\ Iq\end{matrix} \text{} ] + Ls [ \text{} \begin{matrix}id \\ iq\end{matrix} \text{} ] + ω [ \text{} \begin{matrix}- LsIq \\ LsId + λ\end{matrix} \text{} ] \qquad equation ( 2 )$$

Accordingly, the present disclosure mainly proposes a new circuit topology for the motor emulator 100, which is designed to emulate each equivalent circuit component in the motor 100A of FIG. 2A and FIG. 2B by the power stage circuit 2 of the motor emulator 100.

Therefore, the motor emulator 100 can achieve complete restoration of the baseband sine wave and high-frequency ripple components of the actual current of the motor 100A by adjusting the extracted three-phase current Iabc.

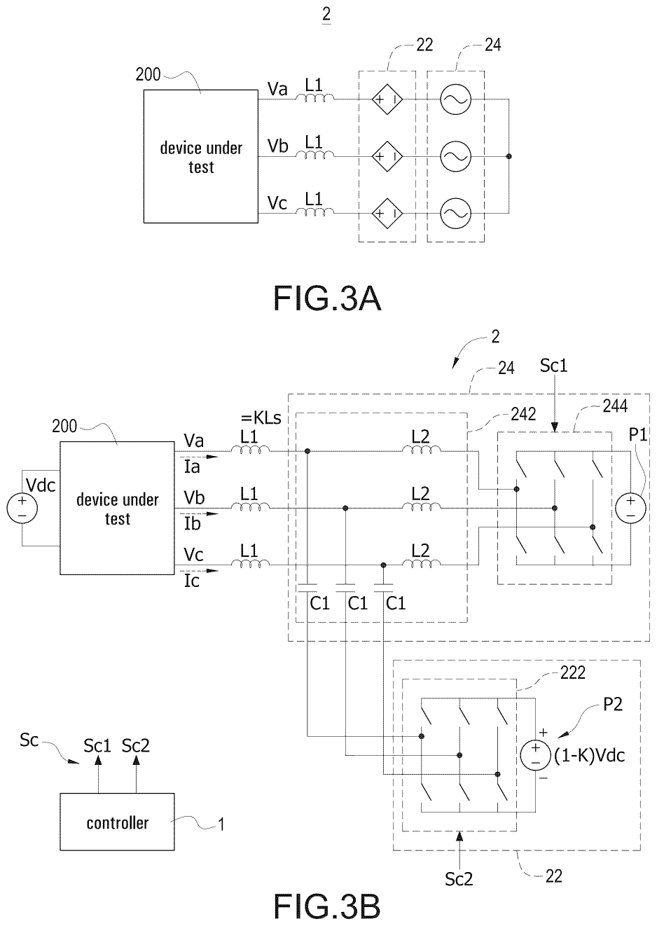

Please refer to FIG. 3A, which shows a schematic model diagram of a power stage circuit topology according to the present disclosure, please refer to FIG. 3B, which shows a circuit diagram of the power stage circuit topology according to the present disclosure, and also refer to FIG. 1 to FIG. 2B. In FIG. 3A, the power stage circuit 2 includes a first three-phase inductor L1, an inductance compensator 22, and a back-EMF emulator 24. In particular, the first three-phase inductor L1 corresponds to the magnetizing inductance (Lsa, Lsb, Lsc) in the motor 100A. However, since different motors 100A should have different inductances, the first three-phase inductor L1 and the magnetizing inductance (Lsa, Lsb, Lsc) should have different inductances, and therefore the present disclosure uses the inductance compensator 22 to make up for the difference in inductance between the two. Furthermore, the coil resistance (Rsa, Rsb, Rsc) of the motor 100A will generate a voltage drop during actual operation, and this voltage drop may also be achieved by the inductance compensator 22 or the back-EMF emulator 24. In addition, the back EMF (ea, eb, ec) of the motor 100A can be emulated by the back-EMF emulator 24.

FIG. 3B is a physical circuit application of the topological model of the power stage circuit 2 of FIG. 3A, but it is only one of many preferred implementations and is not limited here. In FIG. 3B, the controller 1 is coupled to the device under test 200, and correspondingly calculates the three-phase current Iabc that should be provided by the device under test 200 according to the output signal Vabc provided by the device under test 200. After calculating, the controller 1 provides a control signal Sc corresponding to the three-phase current Iabc to the power stage circuit 2 to control the power stage circuit 2 to extract the three-phase current Iabc corresponding to the output signal Vabc to emulate the dynamic response of the motor 100A. In particular, the output signal Vabc may be a pulse-width modulation (PWM) signal, and a voltage level of the output signal Vabc (i.e., the PWM signal) may be two voltage levels (for example, but not limited to, a high level and a low level) or three more voltage levels (in addition to the high level and the low level, other levels may include, for example but not limited to, intermediate levels or negative levels).

In physical circuit applications, the power stage circuit 2 is coupled to the controller 1 and the device under test 200, and the power stage circuit 2 includes a first three-phase inductor L1, an inductance compensator 22, and a back-EMF emulator 24. Specifically, the first three-phase inductor L1 is coupled to the device under test 200, and the back-EMF emulator 24 is coupled to the first three-phase inductor L1. The inductance compensator 22 is coupled to the first three-phase inductor L1 and the back-EMF emulator 24. The controller 1 provides a control signal Sc to the back-EMF emulator 24 and the inductance compensator 22 to control the power stage circuit 2 to extract a three-phase current Iabc corresponding to the output signal Vabc. Furthermore, the control signal Sc includes a first control signal Sc1 and a second control signal Sc2. The controller 1 provides the first control signal Sc1 to the back-EMF emulator 24 to control the back-EMF emulator 24 to emulate a back EMF corresponding to the output signal Vabc. Furthermore, the controller 1 provides the second control signal Sc2 to the inductance compensator 22 to control the inductance compensator 22 to compensate the first three-phase inductor L1 so as to emulate a magnetizing inductance Ls of the motor 100A. Therefore, the controller 1 controls the back-EMF emulator 24 and the inductance compensator 22 through the first control signal Sc1 and the second control signal Sc2 respectively so that the power stage circuit 2 extracts the three-phase current Iabc corresponding to the output signal Vabc according to the back EMF and the magnetizing inductance Ls. Therefore, the dynamic response of the motor 100A may be emulated by restoring the three-phase current Iabc.

Please refer to FIG. 2A to FIG. 3B. The inductance value of each phase inductance value of the first three-phase inductor L1 may preferably be the same, and the inductance value may be a fixed value. Furthermore, the inductance value of the first three-phase inductor L1 is not exactly the same as the magnetizing inductance Ls of the motor 100A to be emulated, and generally differs by a multiplier value K (K may be a constant). For example, when the inductance value of the first three-phase inductor L1 is 50 mH and it is desired to emulate a magnetizing inductance Ls of 100 mH, the multiplier value K is 0.5, and so on. The operating principle of the back-EMF emulator 24 is similar to that of the buck (step-down) circuit, and the back-EMF emulator 24 includes a filter circuit 242, a first three-phase switch 244, and a first voltage source P1. The filter circuit 242 is coupled to the first three-phase inductor L1 and the inductance compensator 22. The first three-phase switch 244 is coupled to the filter circuit 242, and the first voltage source P1 is coupled to the first three-phase switch 244. Since the filter circuit 242 is coupled to the first three-phase switch 244, the ripple caused by the first three-phase switch 244 can be reduced by the filter circuit 242.

The filter circuit 242 includes a second three-phase inductor L2 and a three-phase capacitor C1. The second three-phase inductor L2 is coupled to the first three-phase inductor L1 and the first three-phase switch 244, and the three-phase capacitor C1 is coupled to the second three-phase inductor L2 and the inductance compensator 22. In particular, the inductance value of each phase of the second three-phase inductor L2 may preferably be the same, and the inductance may be a fixed value. The inductance compensator 22 includes a second three-phase switch 222 and a second voltage source P2. The second three-phase switch 222 is coupled to the back-EMF emulator 24, and the second voltage source P2 is coupled to the second three-phase switch 222. The second voltage source P2 may preferably be an adjustable voltage source, and the second voltage source P2 may provide a specific voltage to compensate the first three-phase inductor L1. In particular, the second voltage source P2 may preferably provide a specific voltage of (1−K) Vdc (K is the above-mentioned multiplier value, and Vdc is the input voltage used by the device under test 200), which will be further described later.

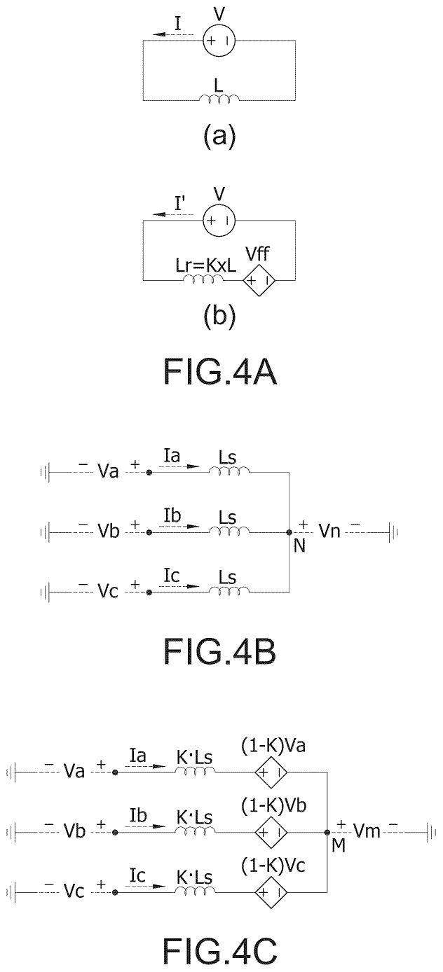

Please refer to FIG. 4A, which an equivalent circuit diagram of a variable inductance to emulate a target inductance, and also refer to FIG. 1 to FIG. 3B. In FIG. 4A, part (a) shows an equivalent circuit of applying voltage to a target inductance, and the target inductance may be regarded as the magnetizing inductance Ls of the motor 100A. In FIG. 4A, part (b) shows the equivalent circuit of applying voltage to the variable inductance, and the magnetizing inductance Ls varies depending on the type of motor 100A, and therefore the difference between its inductance and the inductance value of the first three-phase inductor L1 is a multiple of K. Therefore, the variable inductance in part (b) of FIG. 4A may be used to emulate the target inductance in part (a) of FIG. 4A. Specifically, as shown in part (a), it is assumed that the inductance value of the target inductance is L, and when a voltage V is applied, a current flowing through is I. Based on the definition of the target inductance L, the relationship between the voltage V and the current I is:

$$V = L \frac{dI}{dt} \qquad equation ( 3 )$$

As shown in part (b), if a physical inductance Lr is given, its inductance value differs from the target inductance L by a factor of K, that is, the physical inductance Lr=KL, and a compensation voltage Vff (i.e., a controllable voltage source) is connected in series with the physical inductance Lr. When the same voltage V is applied, the current flowing through the physical inductance Lr is I′. Therefore, the relationship between the voltage V and the current I′ is:

$$V - Vff = KL \frac{{dI}^{′}}{dT} \qquad equation ( 4 )$$

If the physical inductance Lr is to be equal to the target inductance L, that is, I=I′, then the necessary condition Vff=(1−K) V can be acquired (corresponding to the second voltage source P2 providing a specific voltage of (1−K) Vdc). That is, if the controllable voltage source Vff can be controlled to be (1−K) times the applied voltage V, the series circuit of the physical inductor Lr and the controllable voltage source Vff can present the voltage-to-current characteristics that are exactly the same as those of the target inductance L. If the emulated equivalent circuit of the single inductance in part (b) is extrapolated to the Y-connected three-phase magnetizing inductance Ls of the motor 100A, a similar result can be acquired. First, referring to FIG. 4B which is a three-phase Y-connected inductance circuit diagram, the following voltage and current equation can be acquired:

$$[ \text{} \begin{matrix}Va - Vn \\ Vb - Vn \\ Vc - Vn\end{matrix} \text{} ] = [ \text{} \begin{matrix}Ls & 0 & 0 \\ 0 & Ls & 0 \\ 0 & 0 & Ls\end{matrix} \text{} ] [ \text{} \begin{matrix}\frac{d}{dt} Ia \\ \frac{d}{dt} Ib \\ \frac{d}{dt} Ic\end{matrix} \text{} ] \qquad equation ( 5 )$$

Multiplying both sides of equation (5) by the vector [1, 1, 1], equation (6) can be acquired:

$$Va + Vb + Vc - 3 Vn = L \frac{d}{dt} ( Ia + Ib + Ic ) \qquad equation ( 6 )$$

According to Kirchhoff's circuit law at point N, equation (7) can be acquired:

$$Ia + Ib + Ic = 0 \qquad equation ( 7 )$$

Substituting equation (7) into equation (6) to acquire equation (8):

$$Vn = \frac{1}{3} ( Va + Vb + Vc ) \qquad equation ( 8 )$$

Substituting equation (8) back into equation (5), equation (9) can be acquired:

$$\frac{1}{3} [ \text{} \begin{matrix}K ( 2 Va - Vb - Vc ) \\ K ( 2 Vb - Va - Vc ) \\ K ( 2 Vc - Vb - Vb )\end{matrix} \text{} ] = [ \text{} \begin{matrix}KLs & 0 & 0 \\ 0 & KLs & 0 \\ 0 & 0 & KLs\end{matrix} \text{} ] [ \text{} \begin{matrix}\frac{d}{dt} Ia \\ \frac{d}{dt} Ib \\ \frac{d}{dt} Ic\end{matrix} \text{} ] \qquad equation ( 9 )$$

On the other hand, the three-phase Y-connected inductance circuit diagram of FIG. 4B may be replaced by an equivalent emulated inductance circuit diagram as shown in FIG. 4C, and the following voltage and current equation can be acquired:

$$[ \text{} \begin{matrix}Va - ( 1 - k ) Va - Vm ) \\ Vb - ( 1 - k ) Vb - Vm ) \\ Vc - ( 1 - k ) Vc - Vm )\end{matrix} \text{} ] = [ \text{} \begin{matrix}KLs & 0 & 0 \\ 0 & KLs & 0 \\ 0 & 0 & KLs\end{matrix} \text{} ] [ \text{} \begin{matrix}\frac{d}{dt} Ia \\ \frac{d}{dt} Ib \\ \frac{d}{dt} Ic\end{matrix} \text{} ] \qquad equation ( 10 )$$

Multiplying both sides of equation (10) by the vector [1, 1, 1], equation (11) can be acquired:

$$K ( Va + Vb + Vc ) - 3 Vm = KL \frac{d}{dt} [ Ia + Ib + Ic ] \qquad equation ( 11 )$$

According to Kirchhoff's circuit law at point M, equation (12) can be acquired:

$$Ia + Ib + Ic = 0 \qquad equation ( 12 )$$

Substituting equation (12) into equation (11) to acquire equation (13):

$$Vm = \frac{1}{3} K ( Va + Vb + Vc ) \qquad equation ( 13 )$$

Substituting equation (13) back into equation (10), equation (14) can be acquired:

$$[ \text{} \begin{matrix}K ( 2 Va - Vb - Vc ) \\ K ( 2 Vb - Va - Vc ) \\ K ( 2 Vc - Va - Vb )\end{matrix} \text{} ] = [ \text{} \begin{matrix}KLs & 0 & 0 \\ 0 & KLs & 0 \\ 0 & 0 & KLs\end{matrix} \text{} ] [ \text{} \begin{matrix}\frac{d}{dt} Ia \\ \frac{d}{dt} Ib \\ \frac{d}{dt} Ic\end{matrix} \text{} ] \qquad equation ( 14 )$$

Dividing both sides of equation (14) by K, the same voltage-current equation as equation (9) can be acquired. This also means that the circuit diagram of the three-phase Y-connected emulated inductance in FIG. 4C is an equivalent circuit to the three-phase Y-connected inductance in FIG. 4B. Therefore, the three-phase Y-connected inductance (i.e., the magnetizing inductance Ls) of the motor 100A can be realized by using the equivalent circuit of FIG. 4C.

In particular, there are many different implementations of the physical circuit used to implement the equivalent circuit shown in FIG. 4C. It can be realized by an isolated voltage source (i.e., the second voltage source P2) and three bridge arm switches (i.e., the second three-phase switch 222), and will be further described later. Therefore, referring to FIG. 3B and FIG. 4A to FIG. 4C, the controller 1 can provide the second control signal Sc2 to the second three-phase switch 222 according to the output signal Vabc to control the switching of the second three-phase switch 222. Furthermore, the controller 1 can adjust the second voltage source P2 according to the difference K between the inductance value of the magnetizing inductance Ls and the inductance value of the first three-phase inductor L1 and the input voltage Vdc of the device under test 200, i.e., the second voltage source P2 preferably provides a specific voltage of (1−K) Vdc so that the function of the inductance compensator 22 is similar to that of FIG. 4A, and the inductance value of the target inductance L is emulated by adjusting the controllable voltage source Vff.

Therefore, the second voltage source P2 can provide the compensation voltage Vff through the switching of the second three-phase switch 222, and the first three-phase inductor L1 emulates the magnetizing inductance Ls through compensation of the compensation voltage Vff. Furthermore, the purpose of operating the second three-phase switch 222 by the inductance compensator 22 is to actively change a current slope of the first three-phase inductor L1 by compensating a certain voltage (i.e., the compensation voltage Vff), thereby emulating the current slope of the magnetizing inductance Ls of the physical motor. Therefore, the first three-phase inductor L1 with a fixed inductance value can be used to emulate the magnetizing inductance Ls with a variable inductance value, thereby increasing the accuracy of the test.

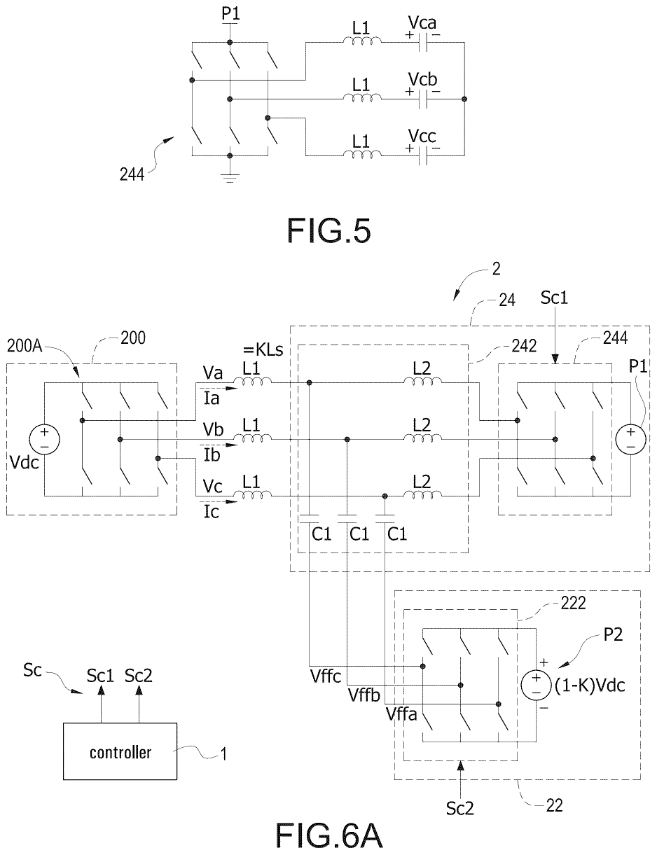

Please refer to FIG. 5, which shows an equivalent circuit diagram of a buck converter that is used to realize the back EMF, and also refer to FIG. 1 to FIG. 4C. In FIG. 5C, the back EMF inside the motor 100A is an AC voltage source with a rotational speed frequency. The AC voltage source is realized by using a controller 1 with sufficient bandwidth in combination with a circuit structure. For example, the back-EMF emulator 24 uses a buck DC-to-AC converter as an illustrative example, which includes a voltage source (corresponding to the first voltage source P1), a three-phase switch (corresponding to the first three-phase switch 244), a three-phase inductor (corresponding to the second three-phase inductor L2), and a three-phase Y-connected output capacitor (corresponding to the three-phase capacitor C1). With high-frequency switching and proper feedback control, the AC voltages Vca, Vcb, Vcc of the rotational speed frequency of the motor 100A can be acquired across the three-phase Y-connected output capacitor. In general, if the three-phase switch of FIG. 5 is controlled by abc axis to dqz axis, the characteristics of the motor equivalent model including an equivalent q-axis back EMF, while a d-axis voltage is zero and a z axis is an open-circuit state (as shown in FIG. 2B) can be generated. Therefore, the back EMF (ea, eb, ec) is expressed as:

$$[ \text{} \begin{matrix}Vca\_ref \\ Vcb\_ref \\ Vcc\_ref\end{matrix} \text{} ] = [ \text{} \begin{matrix}ea \\ eb \\ ec\end{matrix} \text{} ] \qquad equation ( 15 )$$

Therefore, referring to FIG. 3B, FIG. 5 and the above equation (15), the controller 1 can calculate the three-phase current Iabc corresponding to the output signal Vabc according to the motor numerical model 12. The controller 1 provides a first control signal Sc1 to the first three-phase switch 244 of the back-EMF emulator 24 based on the calculated three-phase current Iabc to control the switching of the first three-phase switch 244 so that the back-EMF emulator 24 can adjust the first voltage source P1 to the back EMF corresponding to the three-phase current Iabc by switching the first three-phase switch 244. Furthermore, the controller 1 can emulate the back EMF (ea, eb, ec) on the three-phase capacitor C1 by controlling the switching of the first three-phase switch 244.

In particular, the increase and decrease of a voltage across the three-phase capacitor C1 is proportional to the acceleration and deceleration of the rotor of the motor 100A. Therefore, the gradual increase of the voltage across the three-phase capacitor C1 represents the gradual increase of the back EMF (ea, eb, ec), which can be used to emulate the acceleration of the rotor. On the contrary, the gradual decrease of the voltage across the three-phase capacitor C1 represents the gradual decrease of the back EMF (ea, eb, ec), which can be used to emulate the deceleration of the rotor. In one embodiment, the purpose of operating the first three-phase switch 244 by the controller 1 is to control the voltage across the three-phase capacitor C1 to emulate a back EMF (ea, eb, ec) generated by a physical motor 100A. Therefore, the present disclosure does not limit the operation mode of the first three-phase switch 244, and the physical operation thereof may be controlled by an open loop or a closed loop, and may be operated by a simple or complex controller 1.

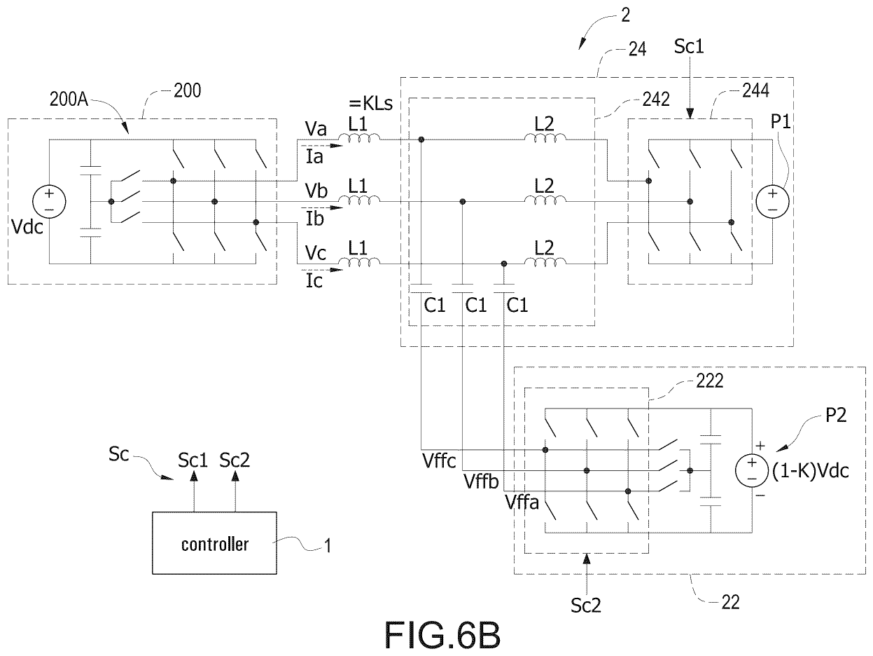

Please refer to FIG. 6A, which shows a circuit diagram of the power stage circuit topology according to a first embodiment of the present disclosure, and also refer to FIG. 1 to FIG. 5. FIG. 6A mainly connects the equivalent emulated inductance circuit proposed in FIG. 2A to FIG. 5 in series with the circuit generating the back EMF to form a complete structure of the power stage circuit 2. Since the inductance compensator 22 emulates a current slope of the magnetizing inductance Ls of the physical motor by compensating a certain voltage (i.e., the compensation voltage Vff), if the correct slope is to be generated, the second three-phase switch 222 should be switched completely synchronously with an inverter 200A of the device under test 200 as a preferred implementation. When the device under test 200 uses the inverter 200A with a different voltage level, the voltage level of the second three-phase switch 222 used by the inductance compensator 22 should also match the voltage level of the inverter 200A to provide compensation voltages Vffa, Vffb, Vffc of each phase having the same voltage level as the inverter 200A.

Taking the device under test 200 is in a two-level voltage switching operation (i.e., two voltage levels), and a-phase as an example. When the a-phase of the device under test 200 is at a high voltage (i.e., the voltage level is Vdc), the upper arm of the a-phase of the second three-phase switch 222 is turned on and the lower arm thereof is turned off so that the a-phase compensation voltage Vffa is connected to a positive terminal of the second voltage source P2 of (1−K) Vdc. On the contrary, when the a-phase of the device under test 200 is at a low voltage (i.e., the voltage level is OV), the upper arm of the a-phase of the second three-phase switch 222 is turned off and the lower arm thereof is turned on so that the a-phase compensation voltage Vffa is connected to a negative terminal of the second voltage source P2 of (1−K) Vdc. In particular, the compensation voltages Vffb, Vffc of the b-phase and the c-phase are similar, and thus will not be repeated.

Please refer to FIG. 6B, which shows a circuit diagram of the power stage circuit topology according to a second embodiment of the present disclosure, and also refer to FIG. 1 to FIG. 6A. The power stage circuit 2 of FIG. 6B is similar to that of FIG. 2A, except that the inverter 200A of the device under test 200 is a multi-stage voltage switching operation (i.e., more than three voltage levels). When the inverter 200A is in the multi-stage voltage switching operation, the required compensation voltages Vffa, Vffb, Vffc can be achieved according to a similar control strategy if only the second three-phase switch 222 connected to the second voltage source P2 of (1−K) Vdc is changed into three multi-stage switches, and the operation is similar to that in FIG. 6A and will not be described in detail here.

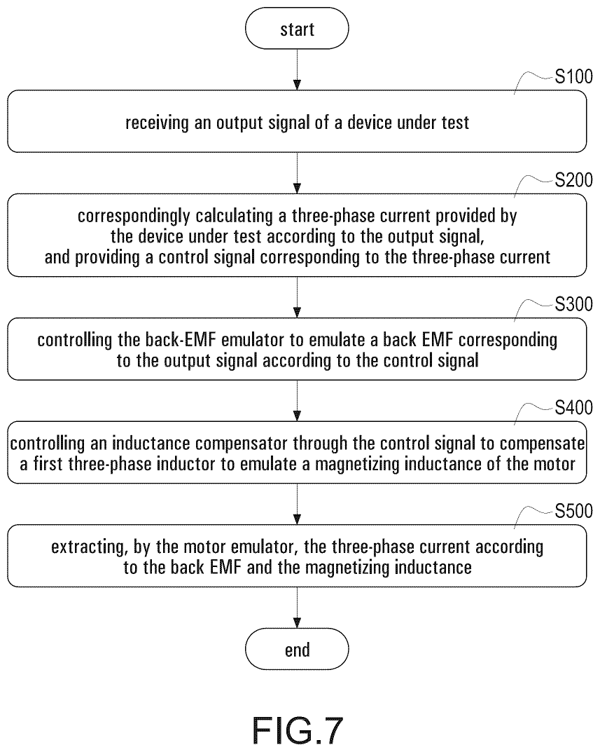

Please refer to FIG. 7, which shows a flowchart of a method of operating the motor emulator according to the present disclosure, and also refer to FIG. 1 to FIG. 6B. The method of operating the motor emulator 100 of FIG. 7 is mainly to provide corresponding feedback according to the output signal Vabc when the device under test 200 provides the output signal Vabc so that the device under test 200 regards the motor emulator 100 as being connected to a motor. Therefore, the method of operating the motor emulator 100 includes steps of: receiving an output signal of a device under test (S100). Afterward, correspondingly calculating a three-phase current provided by the device under test according to the output signal, and providing a control signal corresponding to the three-phase current (S200). A preferred implementation is that the controller 1 may include, for example but not limited to, a motor numerical model 12, or a sub-module such as a specific motor program. Furthermore, the sub-module can perform numerical calculations by sensing the output signal Vabc of the device under test 200, and predict the dynamic response of the motor 100A to be emulated by numerical calculations so as to provide a control signal Sc.

Afterward, controlling the back-EMF emulator to emulate a back EMF corresponding to the output signal according to the control signal (S300). A preferred implementation is that the controller 1 provides a first control signal Sc1 to control a first three-phase switch 244 of a back-EMF emulator 24 so that the first voltage source P1 of the back-EMF emulator 24 is adjusted to a back EMF (ea, eb, ec) corresponding to the three-phase current Iabc through the switching of the first three-phase switch 244. Afterward, controlling an inductance compensator through the control signal to compensate a first three-phase inductor to emulate a magnetizing inductance of the motor (S400). A preferred implementation is that the controller 1 provides a second control signal Sc2 to an inductance compensator 22 to control the inductance compensator 22 to compensate the first three-phase inductor L1 so as to emulate the magnetizing inductance Ls of the motor 100A. Finally, extracting, by the motor emulator, the three-phase current according to the back EMF and the magnetizing inductance (S500). The controller 1 controls the back-EMF emulator 24 and the inductance compensator 22 through the first control signal Sc1 and the second control signal Sc2 respectively so that the power stage circuit 2 extracts the three-phase current Iabc corresponding to the output signal Vabc according to the back EMF and the magnetizing inductance Ls. Therefore, the dynamic response of the motor 100A may be emulated by restoring the three-phase current Iabc. In one embodiment, the detailed steps not described in FIG. 7 may be referred to in conjunction with FIG. 1 to FIG. 6B, or may be inferred from the technical contents of FIG. 1 to FIG. 6B, and will not be described in detail here.

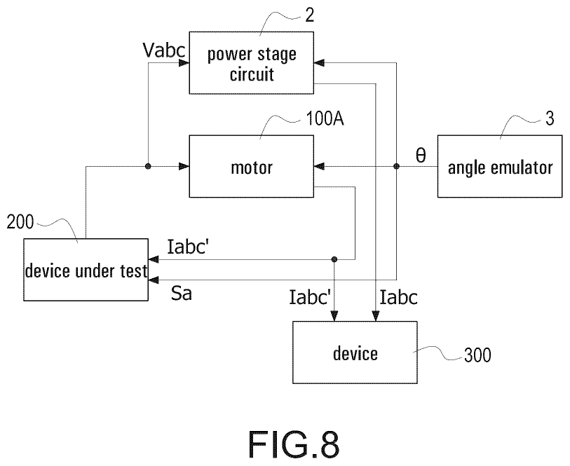

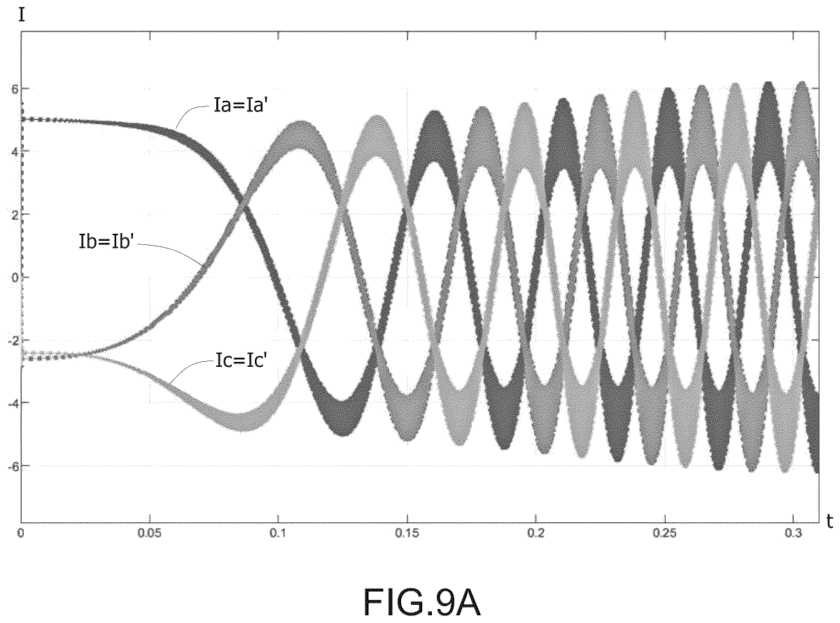

Please refer to FIG. 8, which shows a circuit block diagram of a motor emulator verification system according to the present disclosure, and also refer to FIG. 1 to FIG. 7. The verification system of FIG. 8 is mainly used to verify the accuracy of the motor emulator 100 to emulate the motor 100A. The verification system mainly uses the device under test to simultaneously couple the motor emulator 100 and the motor 100A, and observes the difference between three-phase currents Iabc, Iabc′. Specifically, the verification system can use computer simulation software such as, but not limited to, MATLAB/Simulink to verify the correctness of the motor emulator 100. The verification method of the verification system is that the output terminal of the device under test 200 is coupled to the motor 100A and output current control is performed, and the output terminal of the device under test 200 is also coupled to the motor emulator 100. Therefore, the device under test 200 simultaneously provides the output signal Vabc to the motor 100A and the motor emulator 100.

In order to ensure that the motor 100A and the motor emulator 100 have the same motor speed angle feeding back to the device under test 200 so as to compare the performance of a device 300 used under the same operating conditions, the angle feedback signal Sa is provided by a same device (such as but not limited to the angle emulator 3) to the device under test 200 for the output current control. In particular, the device 300 receives the three-phase current Iabc provided by the motor emulator 100 and the three-phase current Iabc′ provided by the motor 100A, and the three-phase current Iabc′ provided by the motor 100A is fed back to the device under test 200 to perform output current control. Furthermore, the device 300 may be an oscilloscope, a computer or other device with display and processing functions so as to perform a comparison of the difference between the three-phase currents Iabc and Iabc′.

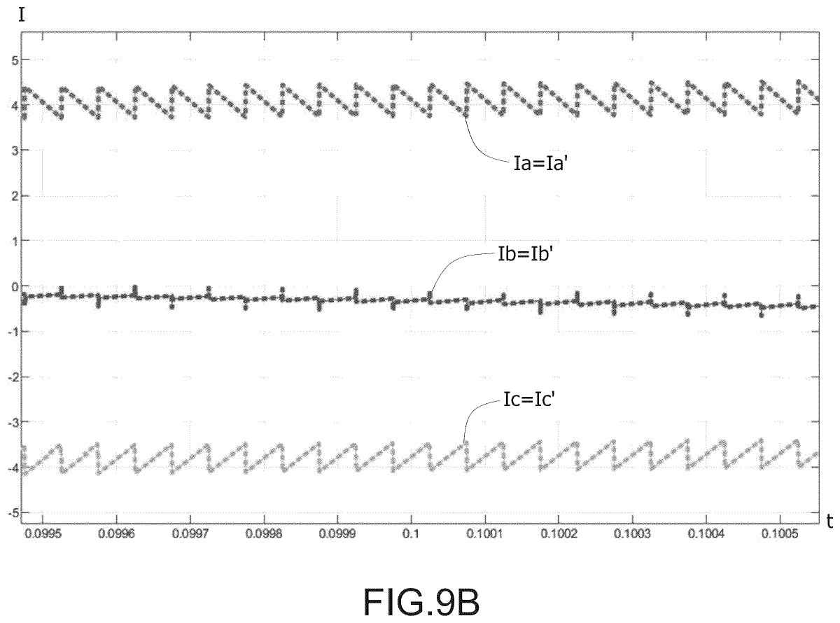

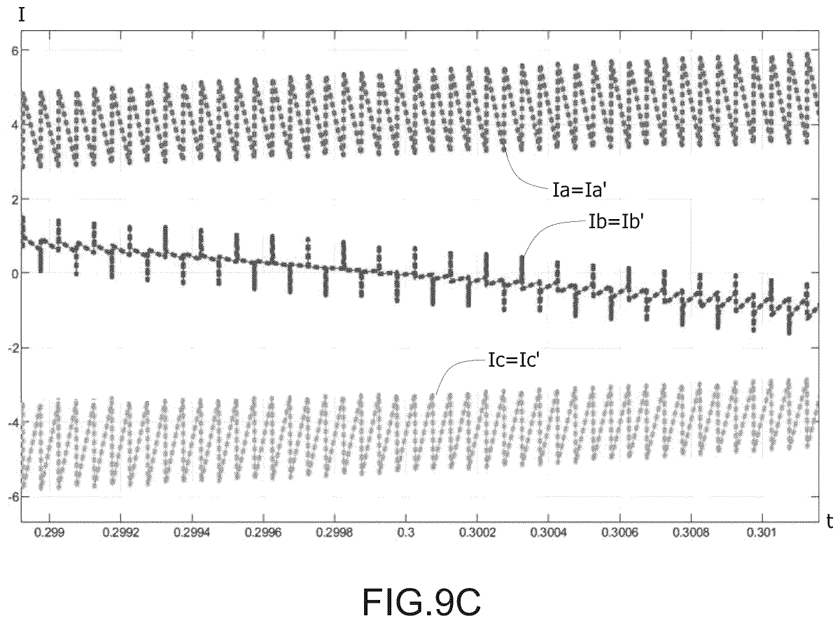

Please refer to FIG. 9A, which shows a comparison diagram of three-phase current waveforms of the verification system according to the present disclosure, please refer to FIG. 9B, which shows a partial enlarged comparison diagram of the three-phase current waveforms at a first time of the verification system according to the present disclosure, please refer to FIG. 9C, which shows a partial enlarged comparison diagram of the three-phase current waveforms at a second time of the verification system according to the present disclosure, and also refer to FIG. 1 to FIG. 8. According to the verification system established in FIG. 8, the current (Ia′, Ib′, Ic′, i.e., the three-phase current Iabc′) flowing into the motor 100A and the current (Ia, Ib, Ic, i.e., the three-phase current Iabc) are shown in FIG. 9A, respectively. Since the three-phase current flowing into the motor emulator 100 and the three-phase current flowing into the motor 100A are almost equal, only one three-phase current is seen in FIG. 9A. That is, the current (Ia′, Ib′, Ic′) flowing into the motor 100A is equal to the current (Ia, Ib, Ic) flowing into the motor emulator 100, causing the two three-phase currents to overlap. FIG. 9B and FIG. 9C are partial enlargements of the current waveform of FIG. 9A at, for example but not limited to, 0.1 and 0.3 seconds, respectively. It can be seen from the partially enlarged waveforms of FIG. 9B and FIG. 9C that even after partial enlargement, the current ripples of the two three-phase currents (Iabc, Iabc′) can be clearly seen, but the two are still almost overlapping. It can be verified that the function of the motor emulator 100 proposed in the present disclosure can compensate the first three-phase inductor L1 by using the inductance compensator 22, and therefore the characteristics of the motor 100A can be accurately emulated and the accuracy of the test can be improved so that the physical motor 100A may be replaced to provide an effective testing environment for the device under test 200.

In addition, referring to FIG. 6A to FIG. 9C, although the first three-phase inductor L1 and the inductance compensator 22 can emulate any value of the magnetizing inductance Ls, when the rotor of the motor 100A rotates, the value of the magnetizing inductance Ls is physically a variable value rather than a constant value, which generally varies within a specific range. Therefore, when the motor 100A is physically running, the inductance values of the three magnetizing inductances Ls (a-phase to c-phase) will be different, but always remain within the specific range. Furthermore, the difference in inductance between the physical magnetizing inductance Ls of the motor 100A and the magnetizing inductance Ls emulated by the motor emulator 100 is only manifested in the phenomenon that the magnitudes of the current ripples shown in FIG. 9B to FIG. 9C are different. Furthermore, although the different values of the magnetizing inductance Ls will affect the overlapping effect of the overall three-phase currents (Iabc, Iabc′) in FIG. 9A, the difference can be fine-tuned by the back-EMF emulator 24, and the effect of roughly overlapping the two three-phase currents (Iabc, Iabc′) can still be achieved.

Therefore, the present disclosure uses the controller 1 to simply set the middle value of a specific range as the inductance value of the magnetizing inductance Ls, rather than adjusting the values of the three excitation inductances Ls (a-phase to c-phase) to follow the motor 100A. Therefore, the motor emulator 100 can be easily implemented and a relatively simple circuit can be used to reduce the circuit cost of the motor emulator 100. Furthermore, in the technical field of the motor 100A, the magnetizing inductance Ls of some specific motors 100A does not vary much during physical operation (for example, but not limited to, permanent magnet synchronous motors), and the specific range is generally within 15% (preferably less than or equal to 15%). Therefore, the motor emulator 100 in the present disclosure is particularly suitable for motors with a specific range of approximately 15% of 100A so that when the device under test 200 is tested, the current ripple can still be kept roughly overlapping with the current ripple when the motor 100A is physically used for testing.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An electronic motor emulator configured to emulate a motor, and receive an output signal of a device under test, the electronic motor emulator comprising:
a controller configured to correspondingly calculate a three-phase current provided by the device under test according to the output signal, and provide a control signal corresponding to the three-phase current, and
a power stage circuit coupled to the controller and the device under test, and the power stage circuit comprising:
a first three-phase inductor coupled to the device under test,
a back-EMF emulator coupled to the first three-phase inductor, and the back-EMF emulator configured to emulate a back EMF corresponding to the output signal according to the control signal, and
an inductance compensator coupled to the back-EMF emulator, and the inductance compensator configured to compensate the first three-phase inductor to emulate a magnetizing inductance of the motor,
wherein the power stage circuit is configured to extract the three-phase current according to the back EMF and the magnetizing inductance.

2. The electronic motor emulator as claimed in claim 1, wherein the back-EMF emulator comprises:
a filter circuit coupled to the first three-phase inductor and the inductance compensator,
a first three-phase switch coupled to the filter circuit, and
a first voltage source coupled to the first three-phase switch,
wherein the controller comprises a predetermined motor numerical model, and the controller is configured to calculate the three-phase current corresponding to the output signal according to the motor numerical model; the controller is configured to control the switching of the first three-phase switch based on the three-phase current so as to adjust the first voltage source to the back EMF corresponding to the three-phase current.

3. The electronic motor emulator as claimed in claim 2, further comprising:
an angle emulator coupled to the controller,
wherein the controller is configured to provide an emulated angle corresponding to a rotor of the motor through the motor numerical model, and the angle emulator is configured to provide an angle feedback signal to the device under test according to the emulated angle.

4. The electronic motor emulator as claimed in claim 2, wherein the filter circuit comprises:
a second three-phase inductor coupled to the first three-phase inductor and the first three-phase switch, and
a three-phase capacitor coupled to the second three-phase inductor and the inductance compensator,
wherein the controller is configured to emulate the back EMF on the three-phase capacitor by controlling the switching of the first three-phase switch.

5. The electronic motor emulator as claimed in claim 4, wherein a rising and a falling of a voltage across the three-phase capacitor is proportional to an acceleration and a deceleration of a rotor of the motor.

6. The electronic motor emulator as claimed in claim 1, wherein the inductance compensator comprises:
a second three-phase switch coupled to the back-EMF emulator, and
a second voltage source coupled to the second three-phase switch,
wherein the controller is configured to control the switching of the second three-phase switch according to the output signal so as to provide a compensation voltage according to the second voltage source, and the first three-phase inductor is configured to emulate the magnetizing inductance according to the compensation voltage.

7. The electronic motor emulator as claimed in claim 6, wherein an inductance value of the first three-phase inductor differs from an inductance value of the magnetizing inductance by a multiplier value, and the controller is configured to adjust the second voltage source according to the multiplier value and an input voltage of the device under test.

8. The electronic motor emulator as claimed in claim 6, wherein the controller is configured to control the switching of the second three-phase switch according to a voltage level of the output signal so as to provide the compensation voltage with a voltage level equal to the voltage level of the output signal.

9. The electronic motor emulator as claimed in claim 8, wherein the output signal is a pulse-width modulation signal, and the output signal has more than three voltage levels.

10. The electronic motor emulator as claimed in claim 1, wherein when a rotor of the motor rotates, the inductance value of the magnetizing inductance varies within a specific range, and the controller is configured to set a middle value of the specific range as the inductance value of the magnetizing inductance so as to control the inductance compensator to emulate the inductance value of the magnetizing inductance through the middle value.

11. The electronic motor emulator as claimed in claim 10, wherein the specific range is substantially within 15%.

12. A method of operating an electronic motor emulator, the electronic motor emulator configured to emulate a motor, and the electronic motor emulator comprising a first three-phase inductor, a back-EMF emulator, and an inductance compensator, the method comprising steps of:
receiving an output signal of a device under test,
correspondingly calculating a three-phase current provided by the device under test according to the output signal, and providing a control signal corresponding to the three-phase current,
controlling the back-EMF emulator to emulate a back EMF corresponding to the output signal according to the control signal,
controlling the inductance compensator through the control signal to compensate the first three-phase inductor to emulate a magnetizing inductance of the motor, and
extracting, by the motor emulator, the three-phase current according to the back EMF and the magnetizing inductance.

13. The method of operating the electronic motor emulator as claimed in claim 12, further comprising steps of:
calculating the three-phase current corresponding to the output signal according to a predetermined motor numerical model, and
controlling the switching of a first three-phase switch of the back-EMF emulator based on the three-phase current to adjust a first voltage source of the back-EMF emulator to the back EMF corresponding to the three-phase current.

14. The method of operating the electronic motor emulator as claimed in claim 13, wherein the motor emulator further comprises an angle emulator, and the method further comprises steps of:
providing an emulated angle corresponding to a rotor of the motor through the motor numerical model, and
providing, by the angle emulator, an angle feedback signal according to the emulated angle.

15. The method of operating the electronic motor emulator as claimed in claim 13, further comprising steps of:
by controlling the switching of the first three-phase switch to emulate the back EMF on a three-phase capacitor of the back-EMF emulator,
rising a voltage across the three-phase capacitor to emulate an acceleration of a rotor of the motor, and
falling the voltage to emulate a deceleration of the rotor.

16. The method of operating the electronic motor emulator as claimed in claim 12, further comprising steps of:
controlling the switching of a second three-phase switch of the inductance compensator according to the output signal so as to provide a compensation voltage according to a second voltage source of the inductance compensator, and
emulating the magnetizing inductance through the first three-phase inductor according to the compensation voltage.

17. The method of operating the electronic motor emulator as claimed in claim 16, further comprising steps of:
acquiring a multiplier value of a difference between an inductance value of the first three-phase inductor and an inductance value of the magnetizing inductance, and
adjusting the second voltage source according to the multiplier value and an input voltage of the device under test.

18. The method of operating the electronic motor emulator as claimed in claim 16, further comprising steps of:
controlling the switching of the second three-phase switch according to a voltage level of the output signal, and
providing the compensation voltage with a voltage level equal to the voltage level of the output signal according to the switching of the second three-phase switch.

19. The method of operating the electronic motor emulator as claimed in claim 12, wherein when a rotor of the motor rotates, the inductance value of the magnetizing inductance varies within a specific range, and the method further comprises steps of:
setting a middle value of the specific range as the inductance value of the magnetizing inductance, and
controlling the inductance compensator to emulate the inductance value of the magnetizing inductance through the middle value.
